(19) United States
(12) Patent Application Publication
(10) Pub. No.: US 2010/0164462 A1
(43) Pub. Date: Jul. 1, 2010

(54) DC-DC CONVERTER PROVIDING SOFT-START FUNCTIONS

(76) Inventors: Chih-Yueh Yen, Hsinchu County (TW); Cheng-Kuang Lin, Nantou City (TW)

Correspondence Address: NORTH AMERICA INTELLECTUAL PROPERTY CORPORATION, P.O. BOX 506, MERRIFIELD, VA, 22116, US

(21) Appl. No.: 12/356,085

(22) Filed: Jan. 20, 2009

(30) Foreign Application Priority Data
Dec. 25, 2008 (TW) 097150625

(51) Int. Cl. G05F 1/00

(52) U.S. Cl. 323/288

(57) ABSTRACT

A DC-DC converter includes a switch circuit, a feedback circuit, an error amplifier, a soft-start circuit, and a signal modulation circuit. The switch circuit receives an input voltage and charges/discharges an inductor based on a switch control signal, thereby providing an output voltage. The feedback circuit provides a corresponding feedback voltage based on the output voltage. The error amplifier generates a comparing voltage based on the feedback voltage and a reference voltage. The soft-start circuit provides a ramp clamping voltage, which is outputted as the comparing voltage when the comparing voltage is larger than the ramp clamping voltage. The signal modulation circuit generates the switch control signal based on the comparing signal and a periodic signal.

### BACKGROUND OF THE INVENTION

1. Field of the Invention

The present invention is related to a voltage converter, and more particularly, to a voltage converter providing soft-start functions.

2. Description of the Prior Art

Voltage converters are commonly used for providing various operational voltages in the power management of a system. A well-designed voltage converter can provide a steady output voltage and a wide range of output currents. In response to a sudden change in the output voltage, the output voltage is maintained at a constant level and a corresponding load current is provided, thereby achieving efficient voltage conversion.

Reference is made to FIG. 1 for a diagram illustrating a prior art DC-DC converter 100. The DC-DC converter 100, comprising an error amplifier 10, a sawtooth wave generator 20, a pulse width modulation (PWM) circuit 30, a switch circuit 40, a feedback circuit 50 and an inductor L, can convert an input voltage V_{IN} into an output voltage V_{OUT} for driving a load (represented by an inductor C_{L}). The switch circuit 40 includes two transistor switches MP and MN. The turned-on transistor switch MP can provide a path for charging the inductor L, while the turned-on transistor switch MN can provide a path for discharging the inductor L. The feedback circuit 50 can detect variations in the output voltage V_{OUT} by voltage-dividing the output voltage V_{OUT} using two serially-coupled resistors R1 and R2, thereby generating a corresponding feedback voltage V_{FB}. Based on the difference between the feedback voltage V_{FB} and a reference voltage V_{REF}, the error amplifier 10 can generate a corresponding comparing voltage V_{COMP}. Upon receiving the comparing voltage V_{COMP} transmitted from the error amplifier 10 and a sawtooth wave transmitted from the sawtooth wave generator 20, the PWM circuit 30 can generate corresponding switch control signals in order to turn on or turn off the transistor switches MP and MN of the switch circuit 40, thereby providing appropriate load currents and stable output voltages by charging or discharge the inductor L.

Reference is made to FIG. 2 for a signal diagram illustrating the operation of the prior art DC-DC converter 100 during start-up. When the DC-DC converter 100 enters the initial stage of start-up T_{ST}, in which the output voltage V_{OUT} generally has a low level and the inductor current is substantially zero, the feedback voltage V_{FB} slowly increases from zero. Since the error amplifier 10 compares the feedback voltage V_{FB} having a substantially zero level to the reference voltage V_{REF} having a higher level, a comparing voltage V_{COMP} having a high level is thus generated during start-up. By raising the output voltage V_{OUT} having a low level to the required voltage level rapidly during start-up, the prior art DC-DC converter 100 generates a sudden large inrush inductor current I_{L} which causes undesired voltage overshoot.

Soft-start circuits are normally employed to increase the stability of the system during start-up operations. U.S. Pat. No. 5,917,313 “DC-to-DC converter with soft-start error amplifier and associated method” (hereafter referred to as the first prior art) discloses a DC-DC converter providing soft-start functions. In the first prior art, the reference voltage V_{REF} is increased gradually during the start-up period so as to reduce the difference between the feedback voltage V_{FB} and the reference voltage V_{REF}, thereby reducing the impacts of sudden inrush current and voltage overshoot. However, the effect of soft-start in the first prior art is limited since the comparing voltage V_{COMP} cannot be directly controlled.

U.S. Pat. No. 4,806,842 “Soft start for five pin switching regulators” (hereafter referred to as the second prior art) discloses a five pin switching regulator providing soft-start functions. In the second prior art, a soft-start circuit comprising comparators and flip-flops is used for controlling the comparing voltage V_{COMP}, thereby reducing the impacts of sudden inrush current and voltage overshoot. However, the soft-start circuit of the second prior art only functions during the start-up period.

U.S. Pat. No. 7,378,827 “Analog internal soft-start and clamp circuit for switching regulator” (hereafter referred to as the third prior art) discloses an analog internal soft-start and clamp circuit for switching regulators. The third prior art utilizes a two-stage current divider circuit to generate a very low, stable current signal, and an integrator circuit including a relatively small, integral capacitor to generate the ramped voltage signal in response to the very low current signal. The analog voltage clamp circuit clamps the regulated output signal to the ramped voltage until the ramped voltage signal increases to a predetermined voltage level, thereby causing the regulated output voltage to exhibit the desired soft-start characteristics. However, the soft-start circuit of the third prior art only functions during the start-up period.

### SUMMARY OF THE INVENTION

The present invention provides a voltage converter providing soft-start functions, comprising a switch circuit for receiving an input voltage and providing an output voltage by charging or discharging an inductor based on a switch control signal; a feedback circuit for providing a corresponding feedback voltage based on the output voltage; an error amplifier for generating a corresponding comparing voltage based on the feedback voltage and a reference voltage; a soft-start circuit comprising: a voltage generating circuit for providing a ramped clamping voltage; and a claming circuit for outputting the ramped clamping voltage as the output voltage when the comparing voltage is greater then the ramped clamping voltage; and a signal modulating circuit for generating the switch control signal based on the comparing voltage and a periodic signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art DC-DC converter.

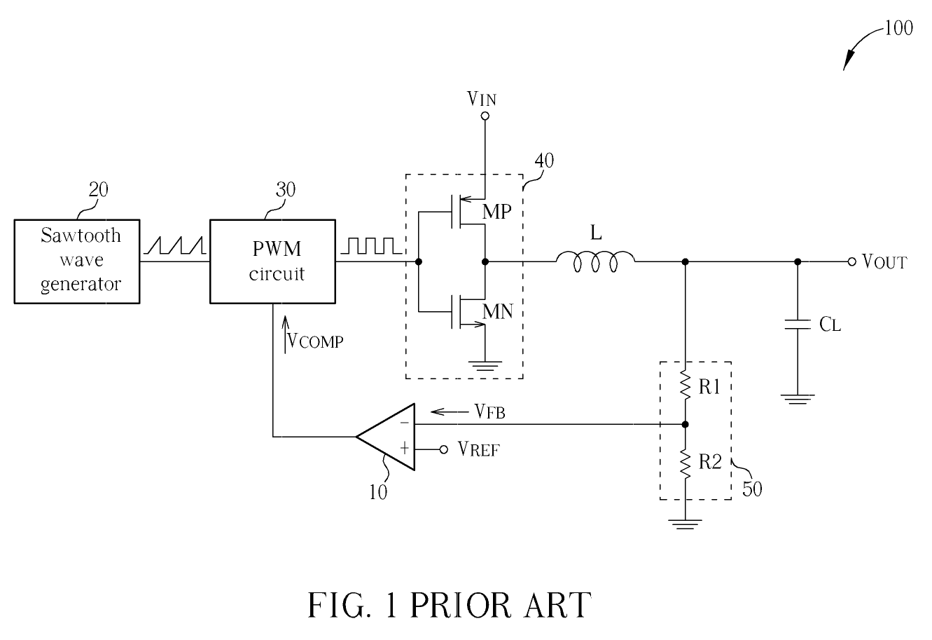

FIG. 2 is a signal diagram illustrating the operation of the prior art DC-DC converter during start-up.

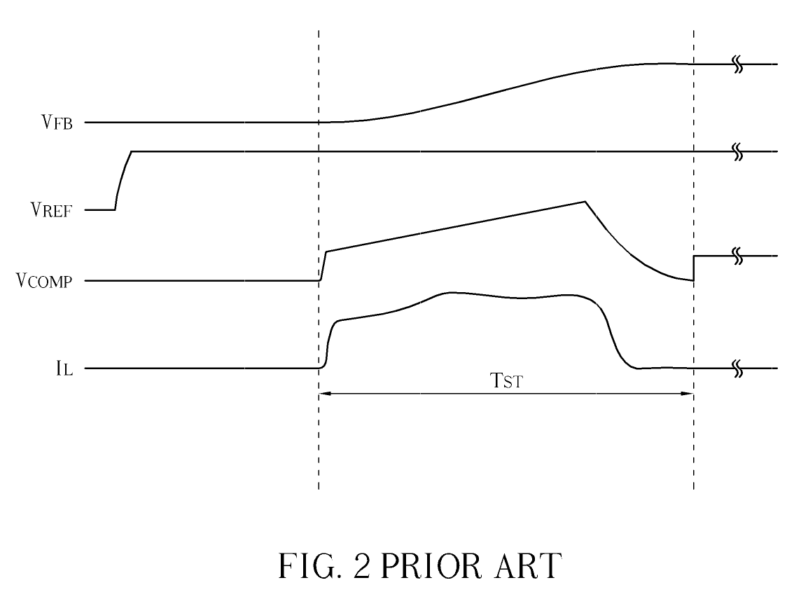

FIG. 3 is a diagram illustrating a DC-DC converter providing soft-start functions according to the present invention.

FIG. 4 is a diagram illustrating a soft-start circuit according to the present invention.

FIG. 5 is a signal diagram illustrating the operation of the present DC-DC converter during start-up.

### DETAILED DESCRIPTION

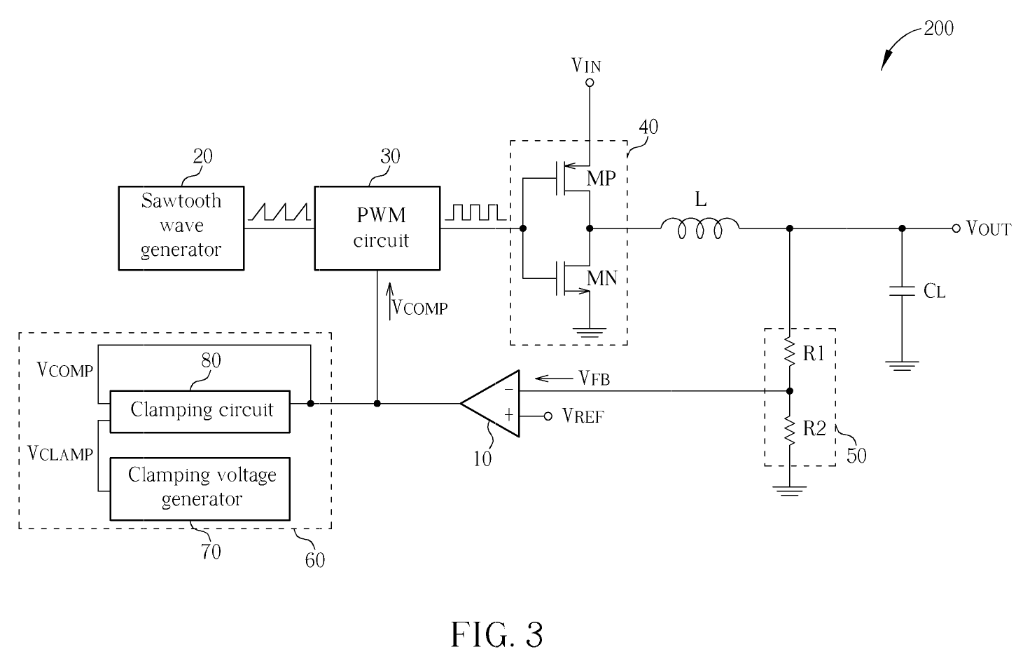

Reference is made to FIG. 3 for a diagram illustrating a DC-DC converter 200 providing soft-start functions according to the present invention. The DC-DC converter 200, comprising an error amplifier 10, a sawtooth wave generator 20, a PWM circuit 30, a switch circuit 40, a feedback circuit 50, a soft-start circuit 60 and an inductor L, can convert an input voltage V_{IN} into an output voltage V_{OUT} for driving a load (represented by an inductor C_{L}). The switch circuit 40 includes two transistor switches MP and MN. The turned-on transistor switch MP can provide a path for charging the inductor L, while the turned-on transistor switch MN can provide a path for discharging the inductor L. The feedback circuit 50 can detect variations in the output voltage V_{OUT} by voltage-dividing the output voltage V_{OUT} using two serially-coupled resistors R1 and R2, thereby generating a corresponding feedback voltage V_{FB}. Based on the difference between the feedback voltage V_{FB} and a reference voltage V_{REF}, the error amplifier 10 can generate a corresponding comparing voltage V_{COMP}. Upon receiving the comparing voltage V_{COMP} transmitted from the error amplifier 10 and a sawtooth wave transmitted from the sawtooth wave generator 20, the PWM circuit 30 can generate corresponding switch control signals in order to turn on or turn off the transistor switches MP and MN of the switch circuit 40, thereby providing appropriate load currents and stable output voltages by charging or discharge the inductor L.

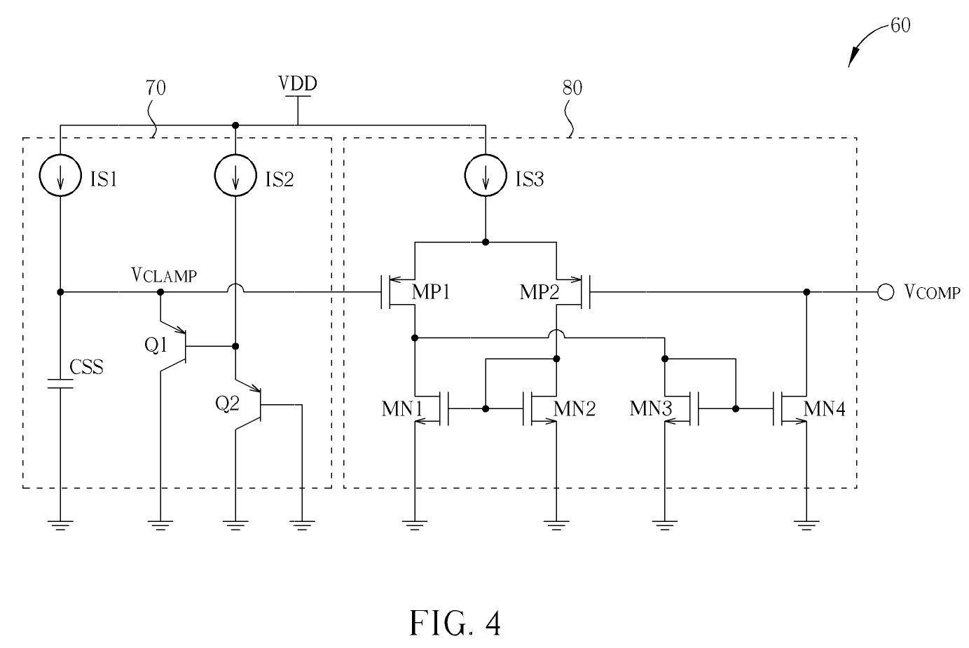

Reference is made to FIG. 4 for a diagram illustrating the soft-start circuit 60 according to the present invention. In the soft-start circuit 60, the clamping voltage generator 70 includes a capacitor CSS, transistor switches Q1, Q2, and current sources IS1, IS2, while the clamping circuit 80 includes transistor switches MP1, MP2, and current sources IS3. In this embodiment, the transistor switches Q1 and Q2 are bipolar junction transistors (BJTs), the transistor switches MP1 and MP2 are p-type metal oxide semiconductor field effect transistors (P-MOSFETs), the transistor switches MN1-MN$ are n-type metal oxide semiconductor field effect transistors (N-MOSFETs). However, the present invention can also use other types of transistor switches having similar functions.

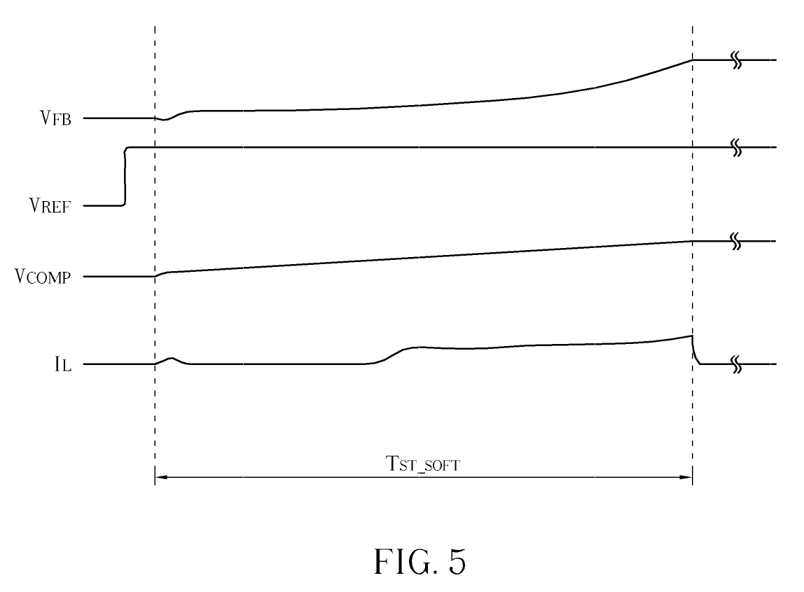

Reference is made to FIG. 5 for a signal diagram illustrating the operation of the present DC-DC converter 200 during start-up. Compared to the start-up period T_{ST} of the prior art DC-DC converter 100, the present DC-DC converter 200 features a longer start-up period T_{ST}_{_{—}}_{SOFT} (about 5 times of T_{ST}). When the DC-DC converter enters the initial stage of start-up, the output voltage V_{OUT} generally has a low level and the feedback voltage V_{FB} is substantially zero. Without soft-start control, the stability of the system may be influenced by an overshoot comparing voltage V_{COMP}. Therefore, the soft-start circuit 60 of the present DC-DC converter 200 is used for performing soft-start operation. When the DC-DC converter 200 enters the initial stage of start-up T_{ST}_{_{—}}_{SOFT}, in which the comparing voltage V_{COM} is larger than the clamping voltage V_{CLAMP}, the soft-start circuit 60 limits the level of the comparing voltage V_{COM} to that of the clamping voltage V_{CLAMP}. Meanwhile, the voltage source VDD begins to charge the capacitor CSS, thereby slowly increasing the clamping voltage V_{CLAMP}. When the clamping voltage V_{CLAMP} is larger than the comparing voltage V_{COM}, the transistor switch MN4 of the clamping circuit 80 is turned off, and the DC-DC converter 200 can thus function normally. In other words, the soft-start circuit 60 can directly control the comparing voltage V_{COM} by providing a steadily-increased comparing voltage V_{COM} when V_{CLAMP}<V_{COMP}. The inductor current I_{L} can thus increase stably without causing sudden inrush current and voltage overshoot.

On the other hand, the clamping voltage V_{CLAMP} is kept at a predetermined level V_{CLAMP}_{_{—}}_{MAX} after completing start-up, and the DC-DC converter 200 can function normally. In this embodiment, the predetermined level V_{CLAMP}_{_{—}}_{MAX} is provided by the total emitter-base voltage (2V_{EB}) of the two cascade BJT switches Q1 and Q2. However, there are still two cases in which a sudden large inrush inductor current I_{L} may occur, resulting in power consumption and overshoot voltage. The first case is the switching from the light-load mode to the heavy-load mode, in which the output voltage V_{OUT} and its corresponding feedback voltage V_{FB} are suddenly pulled down. The second case is the operation in the highly efficient light-load mode, in which the system is shut down and enters the power-saving mode when the output voltage is charged to the predetermined level, and leaves the power-saving mode when the output voltage drops below the predetermined level. Without further control, both cases result in a sudden large overshoot comparing voltage V_{COMP} since the feedback voltage V_{FB} is smaller than the reference voltage V_{REF}. Therefore, the soft-start circuit 60 of the present DC-DC converter 200 is used for controlling the operations during the switching between the light-load mode and the heavy-load mode, as well as in the operations in the light-load mode. When leaving the power-saving mode and entering the normal mode, the suddenly pulled-up comparing voltage V_{COMP} becomes larger than the clamping voltage V_{CLAMP}, and the transistor switch MN4 is turned on. The soft-start circuit 60 can thus limit the level of the comparing voltage V_{COMP} to that of the clamping voltage V_{CLAMP}, thereby reducing a sudden large inrush inductor current I_{L} and voltage overshoot.

In conclusion, the DC-DC converter having soft-start functions according to the present invention can provide a steadily-increased comparing voltage V_{COMP} during start-up. The inductor current can also increase stably without causing voltage overshoot and inrush current. Meanwhile, the level of the comparing voltage V_{COMP} is limited to that of the clamping voltage V_{CLAMP} when the system switches between the light-load mode and the heavy-load mode or operates in the light-load mode, thereby reducing a sudden large inrush inductor current I_{L} and voltage overshoot.

Those skilled in the art will readily observe that numerous modifications and alterations of the device and method may be made while retaining the teachings of the invention.

What is claimed is:

1. A voltage converter providing soft-start functions, comprising:
a switch circuit for receiving an input voltage and providing an output voltage by charging or discharging an inductor based on a switch control signal;
a feedback circuit for providing a corresponding feedback voltage based on the output voltage;
an error amplifier for generating a corresponding comparing voltage based on the feedback voltage and a reference voltage;
a soft-start circuit comprising:
a voltage generating circuit for providing a ramped clamping voltage; and
a claming circuit for outputting the ramped clamping voltage as the output voltage when the comparing voltage is greater then the ramped clamping voltage; and
a signal modulating circuit for generating the switch control signal based on the comparing voltage and a periodic signal.

2. The voltage converter of claim 1, wherein the voltage generating circuit comprises:
a capacitor for storing charges so as to provide the ramped clamping voltage;
a current source for charging the capacitor; and
a level control circuit for maintaining a level of the ramped clamping voltage.

3. The voltage converter of claim 2, wherein the level control circuit includes bipolar junction transistors (BJTs).

4. The voltage converter of claim 1, wherein the clamping circuit comprises:
a current source;
a first switch including:
a first end coupled to the current source;
a second end; and
a control end for receiving the ramped clamping voltage;
a second switch including:
a first end coupled to the current source;
a second end; and
a control end for receiving the comparing voltage;
a third switch including:
a first end;
a second end coupled to the second end of the first switch; and
a control end;
a fourth switch including:
a first end coupled to the first end of the third switch;
a second end coupled to the second end of the second switch; and
a control end coupled to the second end of the second switch and the control end of the third switch;
a fifth switch including:
a first end coupled to the first end of the third switch;
a second end coupled to the second end of the first switch; and
a control end coupled to the second end of the first switch; and
a sixth switch including:
a first end coupled to the first end of the third switch;
a second end coupled to the control end of the second switch; and
a control end coupled to the control end of the fifth switch.

5. The voltage converter of claim 4, wherein the first and second switches include p-type metal oxide semiconductor field effect transistors (P-MOSFETs).

6. The voltage converter of claim 4, wherein the third through the sixth switches include n-type metal oxide semiconductor field effect transistors (N-MOSFETs).

7. The voltage converter of claim 1 further comprising a sawtooth wave generator for generating the periodic signal.

8. The voltage converter of claim 1 wherein the signal modulating circuit includes a pulse width modulation (PWM) circuit.

9. The voltage converter of claim 1 wherein the switch circuit includes an N-MOSFET and a P-MOSFET.

10. The voltage converter of claim 1 wherein the feedback circuit includes a plurality of resistors coupled in series.
